(19) United States
(12) Patent Application Publication
(10) Pub. No.: US 2026/0334589 A1
(43) Pub. Date: Oct. 29, 2026

(54) SMOKING-RELEVANT INFORMATION MANAGEMENT SYSTEM

(71) Applicant: Japan Tobacco Inc., Tokyo (JP)

(72) Inventors: Takashi FUJIKI, Sumida-ku, Tokyo (JP); Ryo YOSHIDA, Sumida-ku, Tokyo (JP)

(73) Assignee: Japan Tobacco Inc., Tokyo (JP)

(21) Appl. No.: 19/123,397

(22) PCT Filed: Oct. 31, 2022
(86) PCT No.: PCT/JP2022/040794

§ 371 Date: Apr. 23, 2025

(51) Int. Cl. A24F 40/65; A24F 40/20; A24F 40/53; H05B 6/00

(52) U.S. Cl. CPC A24F 40/65; A24F 40/20; A24F 40/53; H05B 6/00

(57) ABSTRACT

A smoking-related information management system includes a cover attachable to a main body with a heating unit for heating a substrate containing an aerosol source. The cover has a transmitter that emits electromagnetic waves. A receiver, located in a smoking-related area, receives these waves and sends the transmitter's ID, along with the start and end times of reception, to a management server. The server, connected to the receiver, includes a memory that stores the transmitter ID and the corresponding reception times for tracking and management purposes.

### CROSS-REFERENCE TO RELATED APPLICATION

The present application is a national stage of International Application No. PCT/JP2022/040794 filed on Oct. 31, 2022, the entire contents of which are incorporated herein by reference.

### TECHNICAL FIELD

The present invention relates to a smoking-related information management system.

### BACKGROUND ART

A device having a function for reporting the state of crowding of a smoking area has been proposed in the past. For example, the device described in PTL 1 comprises a determination means capable of determining a state of crowding of a smoking area, and an output means capable of outputting information relating to a determination result from the determination means, the determination means being capable of determining the state of crowding of the smoking area on the basis of a detection result from a detection means which is provided in an ashtray disposed in the smoking area and is capable of detecting smokers based on a distance from an object.

An aerosol generating device for generating an aerosol without associated burning from a smoking article containing an aerosol source has furthermore been proposed in the past. For example, the aerosol generating device described in PTL 2 comprises: a cylindrical heater capable of heating an outer circumference of a smoking article; a control unit for controlling the heater; and a battery for storing power supplied to the heater and the control unit.

### CITATION LIST

### Patent Literature

[PTL 1] JP 2021-115259 A

[PTL 2] WO 2020/084775 A1 [SUMMARY]

An embodiment of the present disclosure provides a smoking-related information management system comprising: a cover which is attached to a main body having a heating unit for heating a substrate that contains an aerosol source and thereby permits heating of the heating unit by means of the main body, the cover having a transmitter for sending electromagnetic waves; a receiver which is provided in a smoking-related area and receives the electromagnetic waves emitted from the transmitter; and a management server connected to the receiver, wherein the receiver sends, to the management server, identification information of the transmitter on the cover, a date and time of the start of reception of the electromagnetic waves emitted from the transmitter, and a date and time of the end of reception of said electromagnetic waves, and the management server has a memory unit for associating and storing the identification information of the transmitter, and the date and time of the start of reception of the electromagnetic waves and the date and time of the end of reception of said electromagnetic waves.

### BRIEF DESCRIPTION OF DRAWINGS

FIG. 1 shows a configuration example of a smoking-related information management system to which the embodiment is applied.

FIG. 2 is a diagram in which a front face side of an aerosol generating device is viewed from diagonally above.

FIG. 3 is a diagram in which the front face side of the aerosol generating device is viewed from diagonally below.

FIG. 4 is a diagram in which the aerosol generating device from which a shutter has been removed is viewed from above.

FIG. 5 is a diagram in which a main body device with a front panel removed is viewed from a front face.

FIG. 6 is a view of a rear face of the front panel removed from the main body device.

FIG. 7 is a diagram schematically showing an internal configuration of the aerosol generating device.

FIG. 8 is a diagram schematically showing connection relationships of a power source system circuit in the front panel and the main body device.

FIG. 9 shows the configuration of a monitoring device.

FIG. 10 shows a situation of monitoring by the monitoring device, where FIG. 10(A) shows a situation in which the monitoring device detects an aerosol generating device, and FIG. 10(B) shows a detection region of the monitoring device.

FIG. 11 shows a relationship between the detection region of the monitoring device and a smoking area, where FIG. 11(A) shows a case in which the detection region of one monitoring device covers an entire smoking area, and FIG. 11(B) shows a case in which detection regions of two monitoring devices cover an entire smoking area.

FIG. 12 shows the configuration of a management server.

FIG. 13 shows an example of a management table for device information held in a memory unit.

FIG. 14 shows an example of a web page reporting smoking area information.

### DESCRIPTION OF EMBODIMENTS

Embodiments of the present invention will be described in detail below with reference to the appended drawings.

### System Configuration

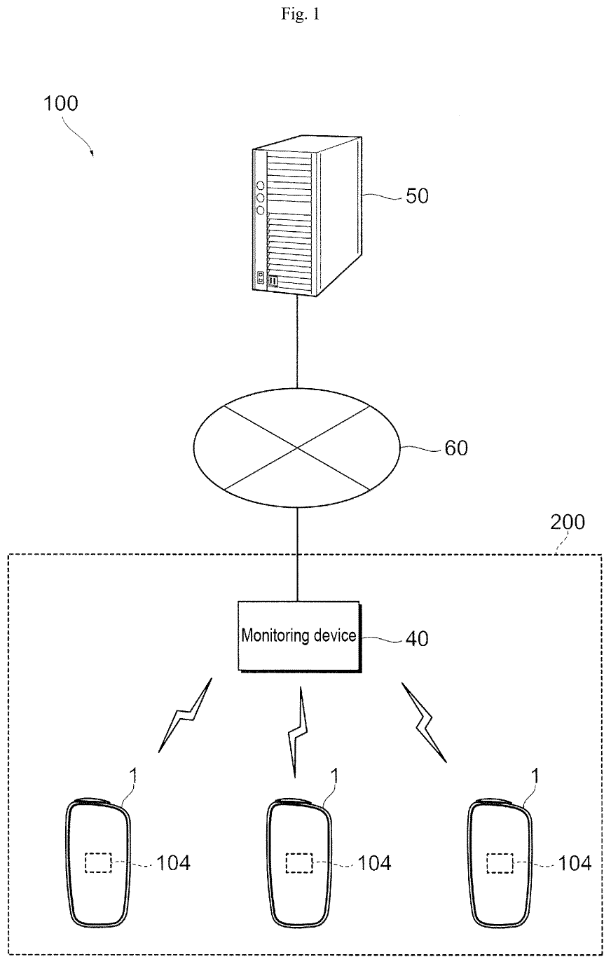

FIG. 1 shows a configuration example of a smoking-related information management system to which the embodiment is applied. A smoking-related information management system 100 comprises aerosol generating devices 1, a monitoring device 40, and a management server 50. The aerosol generating devices 1 are in the possession of users. The users use the aerosol generating devices 1 in a smoking area 200. The monitoring device 40 is installed in a smoking-related area. The management server 50 is connected to the monitoring device 40 via a network 60.

A smoking-related area is a place which is used to acquire information of the users in possession of the aerosol generating devices 1 in the smoking-related information management system 100. Smoking-related areas are not only smoking areas serving as places where smoking is permitted, but also include stores selling tobacco articles, etc. and places where smoking article vending machines are installed, etc., and a smoking-related area is specifically a place where a monitoring device 40 is installed. In the following exemplary case which is described, the smoking area 200 will be taken as an example of a smoking-related area, and the behavior of the users of the aerosol generating devices 1 in the smoking area 200 will be ascertained. It should be noted that the smoking area 200 serves as a space where smoking is permitted, and is a space partitioned by walls and/or dividing screens, for example. Furthermore, even if a space is not partitioned by walls and/or dividing screens, it is set as a space where smoking is permitted, and a range reached by electromagnetic waves sent by a transmitter of the aerosol generating device 1 (to be described later) will be described as the smoking area 200, with the monitoring device 40 at the center.

The aerosol generating device 1 is a form of electronic cigarette. A substance generated by the aerosol generating device 1 is an aerosol. An aerosol is a mixture of minute liquid or solid particles suspended in a gas, and air or another gas. Furthermore, the aerosol generating device 1 comprises a transmitter for sending radio waves which will be described in detail later.

The monitoring device 40 comprises a receiver for receiving radio waves sent from the transmitter of the aerosol generating device 1, and identifies the aerosol generating device 1 which is the source of the received radio waves. Furthermore, the monitoring device 40 sends, to the management server 50 via the network 60, information indicating the start of reception and end of reception of the radio waves sent from the aerosol generating device 1.

The management server 50 manages the number of users in the smoking area 200 on the basis of the information received from the monitoring device 40. Furthermore, the management server 50 reports information such as the number of users in each smoking area 200 using a means such as posting on a website.

There is no particular limitation as to the type or specification of the network 60, provided that it is a network used for data communication between the monitoring device 40 and the management server 50, and examples of networks that may be used include a local area network (LAN), a wide area network (WAN), or the Internet, etc. Communication lines may be wired or wireless, or a mixture thereof. Furthermore, it is also possible to adopt a configuration in which devices are connected via multiple networks and communication lines using a relay device such as a gateway device or a router.

### 1. Configuration of Aerosol Generating Device 1

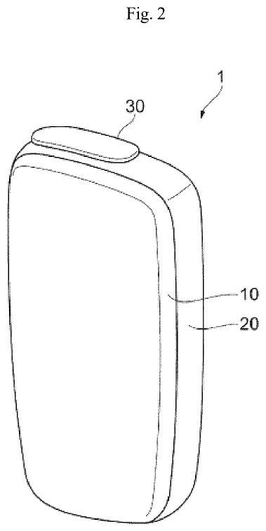

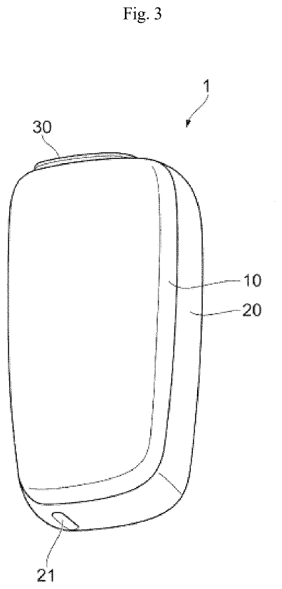

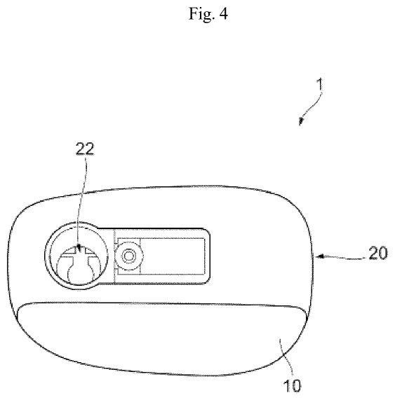

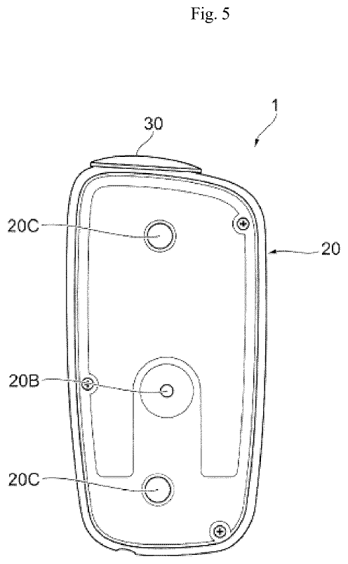

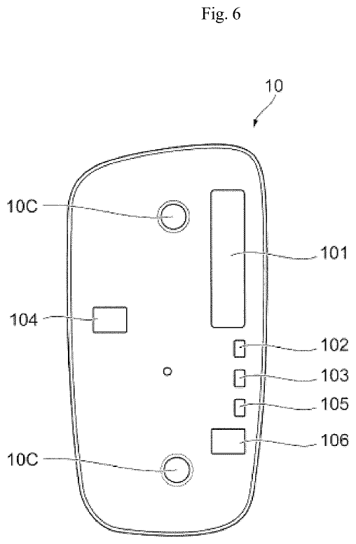

FIG. 2 is a diagram in which a front face side of the aerosol generating device is viewed from diagonally above. FIG. 3 is a diagram in which the front face side of the aerosol generating device is viewed from diagonally below. FIG. 4 is a diagram in which the aerosol generating device from which a shutter has been removed is viewed from above. FIG. 5 is a diagram in which a main body device with a front panel removed is viewed from a front face. FIG. 6 is a view of a rear face of the front panel removed from the main body device.

The aerosol generating device 1 has a size such that a user can hold it in one hand. The aerosol generating device 1 comprises: a main body device 20; a front panel 10 attached to a front face of the main body device 20; and a shutter 30 which is disposed on an upper face of the main body device 20 and can be slidably operated along the upper face. The front panel 10 is a member which is detachable from the main body device 20.

The front panel 10 attached to the main body device 20 covers a front face part of the main body device 20, as shown in FIGS. 2 and 3. In other words, parts of the main body device 20 other than the front face part are not covered by the front panel 10 even after the front panel 10 has been attached. A state is therefore maintained in which side faces, a back face, an upper face, and a bottom face of the main body device 20 are still visible from the outside after attachment of the front panel 10. The front panel 10 attached to the main body device 20 joins continuously and steplessly with the side faces, upper face and bottom face of the main body device 20, forming an integral external appearance, as shown in FIGS. 2 and 3.

The front panel 10 is an example of a cover. In a state in which the front panel 10 is attached to the main body device 20, the front panel 10 has the external appearance of being continuously joined to the main body device 20, as described above, and thus has a decorative role. Furthermore, the front panel 10 also has the role of alleviating propagation of heat released from the main body device 20, etc. In addition, the front panel 10 has the role of protecting the main body device 20 from soiling and scratches, etc.

A power source unit 101 capable of charging/discharging electricity; a charging circuit 102 for charging the power source unit 101 using power supplied from the main body device 20; and an electrical supply circuit 103 for supplying the main body device 20 with power stored in the power source unit 101 are attached to an inner side of the front panel 10. A film-type lithium ion secondary battery or a capacitor, for example, is used for the power source unit 101. It should be noted that the arrangement of the power source unit 101, the charging circuit 102, and the electrical supply circuit 103 in FIG. 6 is merely an example, and the arrangement is not limited to that depicted. Furthermore, a plurality of power source units 101 may be fitted to the front panel 10.

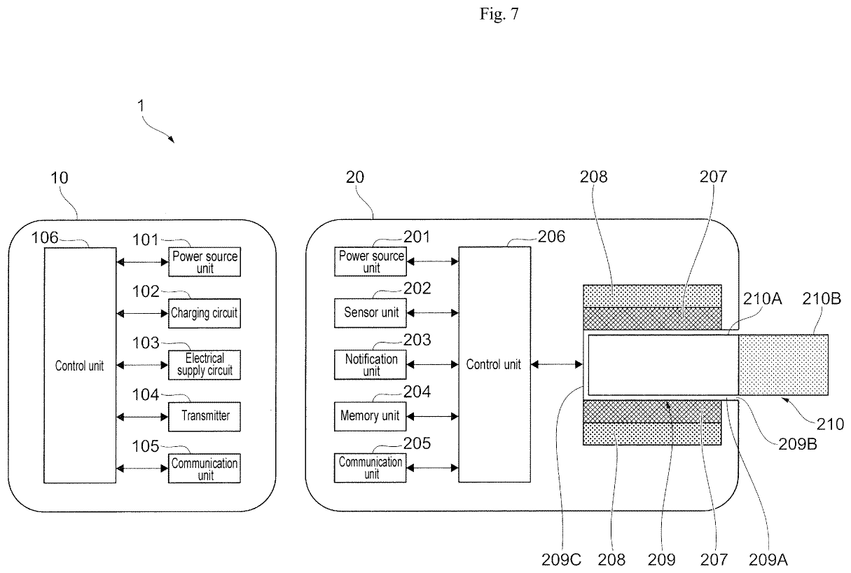

A connector 21 for charging a power source unit 201 (see FIG. 7) built into the main body device 20 is provided on the bottom face side of the main body device 20. There is no particular limitation as to the form of the connector 21, and a Type-C USB (=universal serial bus) connector may be used, to give one example.

A hole 22 for insertion of a stick-type substrate 210 (see FIG. 7) accommodating an aerosol source is provided in an upper face portion of the main body device 20. The stick-type substrate 210 used in the embodiment accommodates a solid aerosol source in a paper tube molded substantially into a cylindrical shape. The hole 22 is exposed by sliding the shutter 30 to an open position, and hidden by sliding the shutter 30 to a closed position. The hole 22 has a cylindrical shape virtually the same as that of the stick-type substrate 210. The diameter of an opening part of the hole 22 constitutes the dimension of a stick-type substrate 210 of cylindrical cross section which can be inserted.

A magnet, for example, is attached to a rear face of the shutter 30. Meanwhile, a Hall IC is attached to the main body device 20 in a movable range of the shutter 30. The Hall IC is a magnetic sensor formed by a Hall element and an operational amplifier, etc., and outputs a voltage commensurate with the intensity of the magnetic field passing across the Hall element. The shutter 30 being in an open position or a closed position is detected from a change in the voltage output from the Hall IC accompanying sliding of the shutter 30.

A button 20B is disposed substantially in the center of the front face of the main body device 20. When a position on the front panel 10 corresponding to the button 20B is pushed in while the front panel 10 is attached to the main body device 20, the front panel 10 deforms and the button 20B is pressed. As a result, the button 20B is operable while the front panel 10 remains in an attached state. The button 20B is used, for example, for turning the power source of the main body device on and off, for turning the power supply to a heating unit 207 (see FIG. 7) for heating the aerosol source on and off, and for Bluetooth (registered trademark) pairing commands, etc. Moreover, a reset function is performed by a long press (e.g., pressing for 5 seconds or more) of the button 20B while the front panel 10 is removed from the main body device 20. BLE (=Bluetooth low energy) is used as Bluetooth, for example.

Magnets 20C used for attaching the front panel 10 are disposed on the upper portion and lower portion of the front face of the main body device 20. The magnets 20C are provided at positions facing magnets 10C provided on the inner side of the front panel 10. The magnets 20C on the main body device 20 and the magnets 10C on the front panel 10 have attracting polarities. When the magnets 10C on the front panel 10 are N poles, the magnets 20C on the main body device 20 side are S poles, for example. The front panel 10 is detachably attached to the main body device 20 by the force of attraction of the magnets. It should be noted that either the magnets 10C or the magnets 20C may be metal pieces made of iron or another magnetic metal. Attachment of the front panel 10 to the main body device 20 is detected by means of the Hall IC provided on the main body device 20 side.

Various other types of electronic components required for generating an aerosol are built into the main body device 20. In this sense, the main body device 20 is an example of an electronic device specifically for generating an aerosol. Moreover, in a narrow sense the main body device 20 is referred to as an aerosol generating device.

### Internal Configuration of Aerosol Generating Device 1

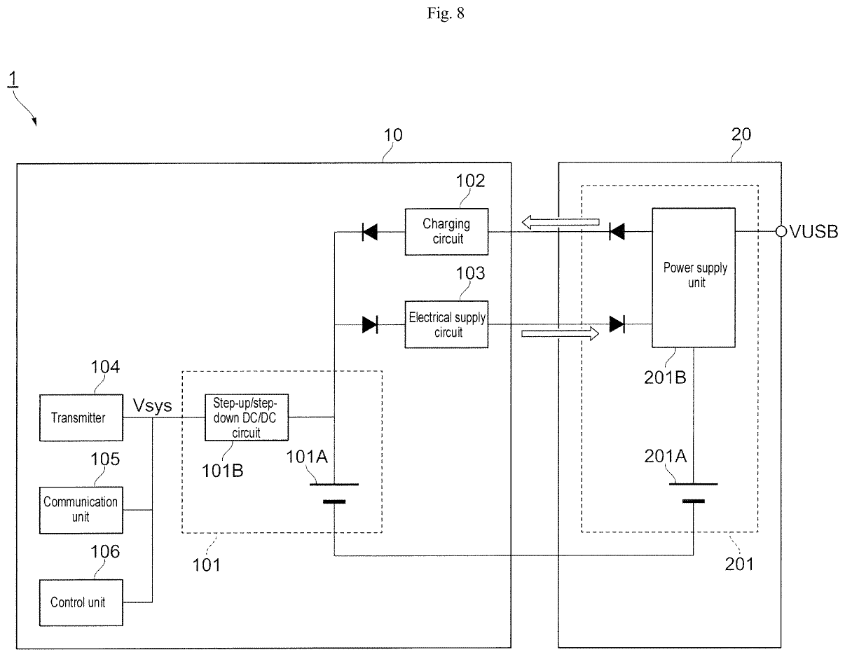

FIG. 7 is a view schematically showing an internal configuration of the aerosol generating device 1. FIG. 8 is a diagram schematically showing connection relationships of a power source system circuit in the front panel 10 and the main body device 20. It should be noted that FIG. 7 shows a state in which the stick-type substrate 210 is fitted to the main body device 20. Furthermore, the internal configuration shown in FIG. 7 is intended to illustrate the components provided in the front panel 10 and the main body device 20 and positional relationships thereof. For this reason, the external appearance of the components, etc. shown in FIG. 7 does not always match the external appearance diagrams described above.

The front panel 10 is provided with: the power source unit 101 for storing electricity; the charging circuit 102 for charging the power source unit 101 using power supplied from the main body device 20 side; the electrical supply circuit 103 for supplying the main body device 20, etc. with power from the power source unit 101; a transmitter 104; a communication unit 105; and a control unit 106.

The power source unit 101 is realized by means of a secondary battery 101A and is further provided with a step-up/step-down DC/DC circuit 101B. A lithium ion secondary battery is used as the secondary battery 101A, for example. In the power source unit 101, the step-up/step-down DC/DC circuit 101B generates a 3.3 V power source Vsys from an output voltage of the secondary battery 101A, and supplies this to the transmitter 104, the communication unit 105, and the control unit 106.

The charging circuit 102 is configured by a step-up DC/DC circuit, for example. The charging circuit 102 is a circuit for supplying a voltage of 4.2 V, for example, to the secondary battery 101A when the charging circuit 102 is supplied with power from the main body device 20. Moreover, the charging circuit 102 is provided with a circuit for preventing a reverse current.

The electrical supply circuit 103 is configured by a step-up DC/DC circuit, for example. The electrical supply circuit 103 is a circuit for supplying a constant voltage (e.g., 5 V) to the main body device 20, regardless of the output voltage of the power source unit 101. Moreover, the electrical supply circuit 103 is provided with a circuit for preventing a reverse current.

Power supply from the main body device 20 to the charging circuit 102 and power supply from the electrical supply circuit 103 to the main body device 20 may be either contact power supply or contactless power supply. Examples of contact power supply methods which may be used include a method using the mechanical contact of electrodes, a method using the mechanical contact of spring-loaded electrode pins (pogo pins), and a method using connector coupling. Contactless power supply may employ power supply based on electromagnetic induction systems, such as the Qi standard and the NFC (=near field communication) standard, and power supply based on electric field induction systems.

The transmitter 104 is a beacon transmitter for periodically and continuously sending signals by radio waves. Signals sent by the transmitter 104 include identification information of the transmitter 104. The identification information of the transmitter 104 may also be used to identify the front panel 10 on which the transmitter 104 is provided, and the aerosol generating device 1 to which this front panel 10 is attached. The identification information of the transmitter 104 may thus be referred to below as identification information of the front panel 10 and identification information of the aerosol generating device 1, etc.

BLE or Wi-Fi (registered trademark), etc., for example, is used as the communication standard used for sending of signals by the transmitter 104. The description below will assume that a BLE beacon is used. It will be assumed that the radio waves sent by the transmitter 104 have a predetermined strength and can be received within a specified range (e.g., a range of 5 m radius, etc.).

The communication unit 105 is a communication interface for performing communication between the main body device 20 and another device. The communication unit 105 is used for acquiring status information from the main body device 20, and for data exchange by connecting with another device such as the management server 50 by means of control of the control unit 106. Communication by the communication unit 105 may employ a system based on any wired or wireless communication standard. Examples of communication standards include wireless LAN (=local area network), serial signal line, Wi-Fi (registered trademark), and Bluetooth, etc.

The control unit 106 is a device for performing various types of arithmetic processing and control in relation to the front panel 10 by reading and executing programs. The control unit 106 is realized by means of an electronic circuit such as a central processing unit (=CPU), a microprocessing unit (=MPU), a graphical processing unit (=GPU), an application-specific integrated circuit (=ASIC), a field programmable gate array (=FPGA), or a digital signal processor (=DSP), for example. The control unit 106 may also include a read only memory (=ROM) for storing programs and computation parameters, etc., and a random access memory (=RAM) for temporarily storing suitably changing parameters, etc.

The control unit 106 controls, for example: communication with the main body device 20, communication with another device such as a smartphone, charging of the secondary battery 101A of the power source unit 101 by means of the charging circuit 102 and the electrical supply circuit 103, and power supply to electronic components, etc. The control unit 106 additionally performs processing, etc. based on input of information to the electronic components on the front panel 10 and information output from the electronic components. Charging from a USB cable is feasible for charging of the secondary battery 101A. Charging from the secondary battery 201A in the main body device 20 could also be possible.

For control in the front panel 10, internal communication between the control unit 106 and the various units employs, for example, a serial communication method such as an inter-integrated circuit (=I2C) communication method, a serial peripheral interface (=SPI) communication method, or a universal asynchronous receiver transmitter (=UART) communication method. An SPI communication method or a UART communication method is used for communication between the control unit 106 and the main body device 20, for example.

The main body device 20 is provided with: a power source unit 201, a sensor unit 202, a notification unit 203, a memory unit 204, a communication unit 205, a control unit 206, a heating unit 207, a heat insulating portion 208, and a holding portion 209. FIG. 7 shows a state in which the stick-type substrate 210 is held in the holding portion 209, and the user inhales the aerosol in this state.

The power source unit 201 is a unit for supplying power to the front panel 10 and the main body device 20. The power source unit 201 stores power using a lithium-ion secondary battery or a capacitor, for example. The example shown in FIG. 8 is configured so that power is stored in the secondary battery 201A. The secondary battery 201A is chargeable from an external power source. A mains power source, a mobile battery, and the secondary battery 101A on the front panel 10, etc. may be used as the external power source, for example.

Furthermore, the power source unit 201 is provided with a power supply unit 201B. The power supply unit 201B switches the supply path of power and converts voltage levels, depending on the operation mode. The power supply unit 201B outputs e.g., 3.3 V to the power source line to which are connected the sensor unit 202, the notification unit 203, the memory unit 204, the communication unit 205, and the control unit 206. Furthermore, the power supply unit 201B outputs e.g., 4.2 V to the power source line to which the heating unit 207 is connected. When the secondary battery 201A is charged by an external power source, the power supply unit 201B outputs e.g., 4.2 V to the power source line to which the secondary battery 201A is connected. A USB cable is used for supplying electricity from a mains power source or a mobile battery serving as an external power source. An electrical supply terminal corresponding to these external power sources is denoted by “VUSB” in FIG. 8.

The sensor unit 202 is an electronic component for detecting various types of information relating to the main body device 20. Sensors constituting the sensor unit 202 include a pressure sensor such as a microphone capacitor, and a flow rate sensor, for example. The sensor unit 202 outputs detected information to the control unit 206. For example, when a change in air pressure or a flow of air accompanying inhalation has been detected, the sensor unit 202 outputs a numerical value representing inhalation by the user to the control unit 206.

The sensor unit 202 has an input device for receiving user input, for example. The input device is realized by means of a button or a switch, for example. The button 20B shown in FIG. 5 is an example of an input device. The button 20B is used for switching a main power source on and off, and for switching starting and stopping of electrical supply to the heating unit 207 (in other words, starting and stopping of aerosol generation), etc. The content of user commands is output from the sensor unit 202 to the control unit 206.

The sensor unit 202 additionally has a temperature sensor for detecting the temperature of the heating unit 207. The temperature sensor detects the temperature of the heating unit 207 on the basis of an electrical resistance value of a conductive track of the heating unit 207, for example. The detected electrical resistance value is output from the sensor unit 202 to the control unit 206. It should be noted that the control unit 206 calculates the temperature of the heating unit 207 on the basis of the electrical resistance value. In other words, the control unit 206 calculates the temperature of the stick-type substrate 210 which is held in the holding portion 209.

The notification unit 203 is an electronic component for notifying the user of various types of information relating to the main body device 20. The notification unit 203 may be configured, for example, by a light-emitting device such as an LED (=light-emitting diode), a display device for displaying images, a sound output device for outputting sounds, or a vibration device for causing the main body device 20 to vibrate, etc. The notification unit 203 may also notify the user of a state in which the aerosol can be inhaled. This notification is made when the temperature of the stick-type substrate 210 heated by means of the heating unit 207 has reached a predetermined temperature.

The memory unit 204 stores various types of information relating to operation of the main body device 20. The memory unit 204 is configured by a non-volatile storage medium such as a flash memory, for example. Information stored in the memory unit 204 includes an operating system (=OS) and firmware (=FW), and other programs, for example. Furthermore, the information stored in the memory unit 204 includes information relating to control of electronic components, for example. The information relating to control includes, for example, information relating to inhalation by the user, such as number of inhalations, times of inhalation, and cumulative inhalation time.

The communication unit 205 is a communication interface for implementing communication between the main body device 20 and another device. The communication unit 205 communicates with other devices by means of a system based on any wired or wireless communication standard. Examples of communication standards include wireless LAN, serial signal line, Wi-Fi, and Bluetooth, etc. For example, the communication unit 205 sends the information relating to user inhalation to a smartphone. Furthermore, the communication unit 205 downloads, from a server, update programs and profiles stipulating changes in temperature of the heating unit 207 in a heating mode. Furthermore, the communication unit 205 sends, to the electrical supply circuit 103, commands for starting and stopping power supply.

The control unit 206 functions as an arithmetic processing device and a control device, controlling operations of the main body device 20 in accordance with various programs. Furthermore, the control unit 206 may control operations of the charging circuit 102 and the electrical supply circuit 103 provided on the front panel 10. Control signals are sent through signal lines different from the power source line. For example, communication inside the main body device 20 employs a serial communication method such as an I2C communication method, an SPI communication method, or a UART communication method. An SPI communication method or a UART communication method is used for communication between the control unit 206 and the charging circuit 102 and electrical supply circuit 103 on the front panel 10. It should be noted that BLE is used for a communication line, for example. The control unit 206 is realized by means of an electronic circuit such as a CPU, MPU, GPU, ASIC, FPGA, or DSP, etc., for example. The control unit 206 may also include a ROM for storing programs and computation parameters, etc., and a RAM for temporarily storing parameters, etc.

The control unit 206 executes various types of processing and control by executing programs. Specifically, the control unit 206 implements: supply of electricity from the power source unit 201 to other electronic components; charging of the power source unit 201; detection of information by the sensor unit 202; notification of information by the notification unit 203; storage and reading of information by the memory unit 204; and sending/receiving of information by the communication unit 205, etc. It should be noted that communication by the communication unit 205 also includes communication with the front panel 10. The control unit 206 additionally controls processing, etc. based on input of information to the electronic components and information output from the electronic components.

The holding portion 209 is a substantially cylindrical container. A space inside the holding portion 209 defined by an inner wall and a bottom face of the container will be referred to as an internal space 209A. The internal space 209A is substantially columnar. An opening 209B allowing the internal space 209A to communicate with the exterior is provided in the holding portion 209. The stick-type substrate 210 is inserted into the internal space 209A from the opening 209B. The stick-type substrate 210 is inserted until a tip end thereof touches a bottom portion 209C. The stick-type substrate 210 is only partially accommodated in the internal space 209A. A state in which the stick-type substrate 210 is accommodated in the internal space 209A will be referred to as the stick-type substrate 210 being held in the internal space 209A.

The inner diameter of at least part of the holding portion 209 in an axial direction thereof is formed so as to be smaller than the outer diameter of the stick-type substrate 210. An outer circumferential surface of the stick-type substrate 210 inserted into the internal space 209A is therefore subjected to pressure from the inner wall of the holding portion 209. The stick-type substrate 210 is held in the internal space 209A by means of this pressure. Furthermore, the holding portion 209 also has a function for defining a flow path for air passing through the stick-type substrate 210. An air inflow hole which is an inlet for air into the flow path is disposed in the bottom portion 209C, for example. Moreover, the opening 209B serves as an air outflow hole which is an outlet for the air.

The holding portion 209 holds a portion of the stick-type substrate 210, with the remaining part of the stick-type substrate 210 protruding outside from a casing of the main body device 20. The part which is held in the holding portion 209 will be referred to below as a substrate portion 210A, and the part protruding from the enclosure will be referred to below as a mouthpiece portion 210B. The aerosol source is accommodated in at least the substrate portion 210A. The aerosol source is a substance which is atomized by heating so as to generate an aerosol. Other than shredded tobacco, the aerosol source contains a processed product obtained by molding a tobacco raw material into a granular form, a sheet form or a powder form, or another tobacco-derived substance. In addition, the aerosol source may also contain a non-tobacco-derived substance produced from a plant other than tobacco, such as mint or herb. The aerosol source may contain a flavoring component such as menthol, for example. When the main body device 20 is a medical inhaler, the aerosol source may contain a drug to be inhaled by a patient. It should be noted that the aerosol source is not limited to a solid, and may equally be a polyhydric alcohol such as glycerol or propylene glycol, or may be a liquid such as water, for example.

At least part of the mouthpiece portion 210B is held in the user's mouth during inhalation. When the user inhales with the mouthpiece portion 210B held in the mouth, air flows into the internal space 209A from the air inflow hole. The air which has flowed in reaches the user's mouth after passing through the internal space 209A and the substrate portion 210A. The air reaching the user's mouth contains the aerosol generated by the substrate portion 210A.

The heating unit 207 is formed by a heater or other heat-generating element. The heating unit 207 is formed by any material such as a metal or polyimide. The heating unit 207 is constructed in the form of a film, for example, and fitted to the outer circumferential surface of the holding portion 209. The aerosol source contained in the stick-type substrate 210 is heated and atomized by the heat generated by the heating unit 207. The atomized aerosol source is mixed with air, etc., and an aerosol is generated. In the example shown in FIG. 7, it is assumed that the outer circumferential region of the stick-type substrate 210 is initially heated, with the range of heating steadily moving toward the center.

Atomization of the aerosol source therefore starts from the outer circumferential region of the stick-type substrate 210 and steadily moves toward the center. The heating unit 207 generates heat by means of electrical supply from the power source unit 201. Electrical supply to the heating unit 207 is permitted when predetermined user input is detected via the sensor unit 202, for example. The user input as referred to here includes operation of the shutter 30 (see FIG. 2) and/or of the button 20B (see FIG. 5). However, electricity is supplied to the heating unit 207 on the assumption that the front panel 10 (see FIG. 2) is attached to the main body device 20. By attaching the front panel 10, the temperature transmitted to the user's hand can be reduced as compared to when the front panel 10 is not attached.

Inhalation by the user becomes possible when the temperature of the stick-type substrate 210 heated by means of the heating unit 207 reaches a predetermined temperature. Inhalation of the aerosol by the user is detected by means of the flow rate sensor, etc. in the sensor unit 202, and information relating to detected inhalation is saved in the memory unit 204. Electrical supply to the heating unit 207 is stopped when predetermined user input is subsequently detected by the sensor unit 202. It should be noted that it is also possible to adopt a method in which electricity is supplied to the heating unit 207 during a period in which inhalation by the user is detected by the sensor unit 202, and electrical supply to the heating unit 207 is stopped when inhalation by the user is no longer detected by the sensor unit 202.

Furthermore, in the example of FIG. 7, the heating unit 207 is disposed outside the stick-type substrate 210, but it is equally possible for the heating unit 207 to be a blade-like metal piece which is inserted into the stick-type substrate 210 for use, or for the heating unit 207 to be a metal piece built into the stick-type substrate 210. When a metal piece acting as the heating unit 207 is built into the stick-type substrate 210, an induction heating coil should be arranged around the holding portion 209.

The heat insulating portion 208 is a member for reducing propagation of heat generated by the heating unit 207 to the surrounding area. The heat insulating portion 208 is therefore disposed so as to cover at least the outer circumferential surface of the heating unit 207. For example, the heat insulating portion 208 is configured by a vacuum insulating material or an aerogel insulating material, etc. A vacuum insulating material is a heat insulating material in which a state of high vacuum is created by wrapping glass wool and silica (silicon powder), etc. in a resin film, for example, so that heat conduction by gas is as close as possible to zero.

### Configuration of Monitoring Device 40

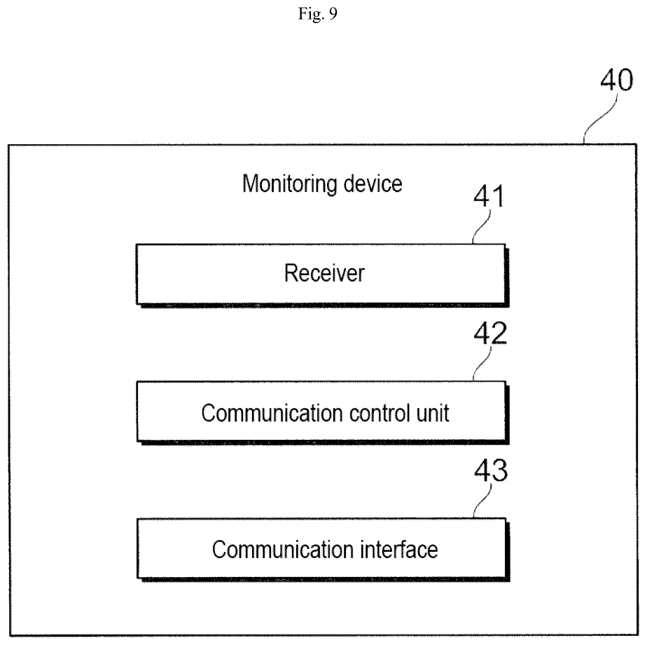

FIG. 9 shows the configuration of the monitoring device 40. The monitoring device 40 is disposed in the smoking area 200 and monitors aerosol generating devices 1 entering and exiting the smoking area 200. The aerosol generating device 1 is carried in the possession of a user, so the aerosol generating device 1 in the possession of that user enters and exits the smoking area 200 together with the user. The monitoring device 40 comprises a receiver 41, a communication control unit 42, and a communication interface 43.

The receiver 41 receives radio waves sent from the transmitter 104 provided on the front panel 10 of the aerosol generating device 1. It will be assumed that the radio waves received by the receiver 41 correspond to those of the transmitter 104: for example, if the transmitter 104 is a beacon transmitter using BLE, the receiver 41 is capable of receiving the BLE radio waves from the transmitter 104. The receiver 41 receiving the radio waves allows the monitoring device 40 to acquire the identification information of the transmitter 104 which sent the radio waves.

The communication control unit 42 judges the start of reception and end of reception for each transmitter 104 on the basis of the situation of radio wave reception by the receiver 41, and specifies a date and time at the start of reception (referred to below as the “reception start date/time”) and a date and time at the end of reception (referred to below as the “reception end date/time”). The communication control unit 42 sends to the management server 50 the reception start date/time and reception end date/time which have been specified.

The judgment as to the start of reception by the communication control unit 42 is made, for example, on the condition that a signal sent from a given transmitter 104 (in other words, a signal containing a given piece of identification information) has been received continuously for a fixed number of times. Furthermore, the judgment as to the end of reception by the communication control unit 42 is made, for example, on the condition that a signal sent from a given transmitter 104 (in other words, a signal containing a given piece of identification information) which was being periodically sent has not been received for a fixed number of times at the periodic reception timing thereof. The reception start date/time and reception end date/time are specified by using a clock function (not depicted) built into the monitoring device 40, for example.

The communication control unit 42 is realized by means of a processor such as a CPU, MPU, GPU, ASIC, FPGA, or DSP, for example. Furthermore, the communication control unit 42 may also include a ROM for storing programs and computation parameters, etc., and a RAM for temporarily storing parameters, etc. which vary, as appropriate, according to the processing which is implemented.

The communication interface 43 is an interface for connecting with the management server 50 via the network 60. When the communication control unit 42 has specified the reception start date/time for a given transmitter 104 in the manner described above, the communication control unit 42 sends, to the management server 50, the identification information and specified reception start date/time of the transmitter 104 using the communication interface 43. Furthermore, when the communication control unit 42 has specified the reception end date/time for a given transmitter 104 in the manner described above, the communication control unit 42 sends, to the management server 50, the identification information and specified reception end date/time of the transmitter 104 using the communication interface 43.

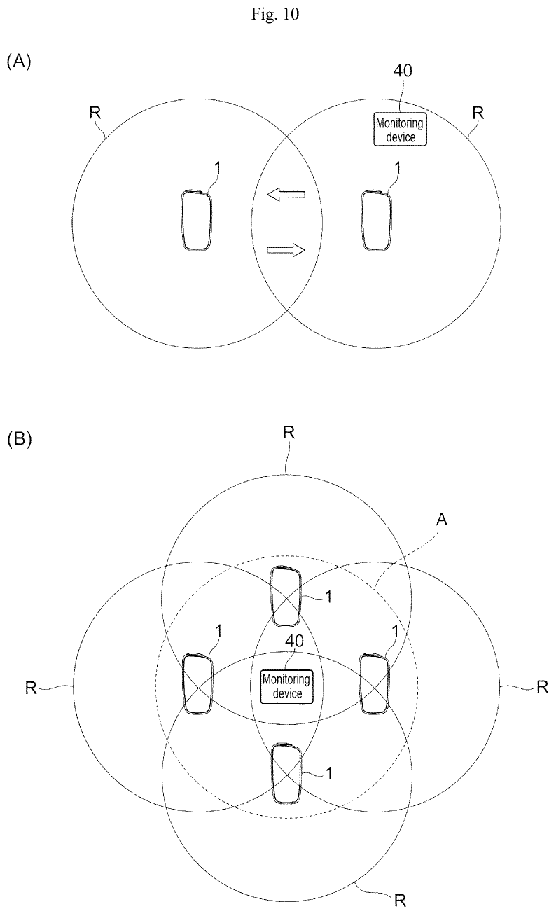

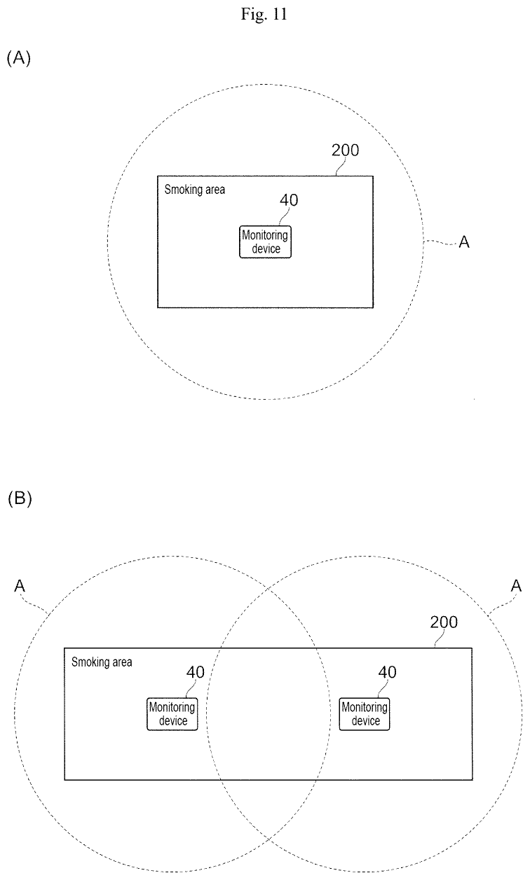

FIG. 10 shows a situation of monitoring by the monitoring device 40, where FIG. 10(A) shows a situation in which the monitoring device 40 detects an aerosol generating device 1, and FIG. 10(B) shows a detection region of the monitoring device 40. FIG. 11 shows a relationship between the detection region of the monitoring device 40 and a smoking area 200, where FIG. 11(A) shows a case in which the detection region of one monitoring device 40 covers an entire smoking area 200, and FIG. 11(B) shows a case in which detection regions of two monitoring devices 40 cover an entire smoking area 200.

It was indicated above that the radio waves sent from the transmitter 104 provided on the front panel 10 of the aerosol generating device 1 can be received within a specified range. A range R around the aerosol generating device 1 shown in FIG. 10(A) will be taken as the range within which the receiver 41 of the monitoring device 40 is capable of receiving the radio waves sent from the transmitter 104. The range R is a substantially circular range centered on the transmitter 104. As shown in FIG. 10(A), when a user in possession of the aerosol generating device 1 is at a distance from the monitoring device 40, and the monitoring device 40 is outside of the range R, the receiver 41 of the monitoring device 40 cannot receive radio waves sent from the transmitter 104, so the monitoring device 40 cannot detect the transmitter 104. When the user moves closer to the monitoring device 40 so that the monitoring device 40 lies within the range R, the receiver 41 of the monitoring device 40 receives the radio waves sent from the transmitter 104, and the monitoring device 40 detects the transmitter 104.

As described above, the receiver 41 of the monitoring device 40 is capable of receiving the radio waves sent from the transmitter 104 within the range R. This means that when a transmitter 104 is within a fixed region A centered on the monitoring device 40, the receiver 41 of the monitoring device 40 is capable of receiving the radio waves sent by that transmitter 104, as shown in FIG. 10(B). The region A is a substantially circular region centered on the receiver 41 and having the same radius as the range R. The size of the region A therefore depends on the strength of radio waves sent by the transmitter 104.

When the number of smokers (users of aerosol generating devices 1) in a smoking area 200 is to be detected, the entire smoking area 200 is preferably contained within the region A, as shown in FIG. 11(A). However, although the size of the region A is based on the strength of radio waves from the transmitter 104, smoking areas 200 have various shapes and sizes. If the region A of one monitoring device 40 cannot cover the entire smoking area 200, a plurality of monitoring devices 40 may therefore be provided so that the regions A of the monitoring devices 40 cover the smoking area 200 together, as shown in FIG. 11(B). In this embodiment, the regions A in which the monitoring devices 40 provided in the smoking area 200 are capable of receiving radio waves from the transmitter 104 will be treated as the smoking area 200, regardless of whether or not there is a partition.

### Configuration of Management Server 50

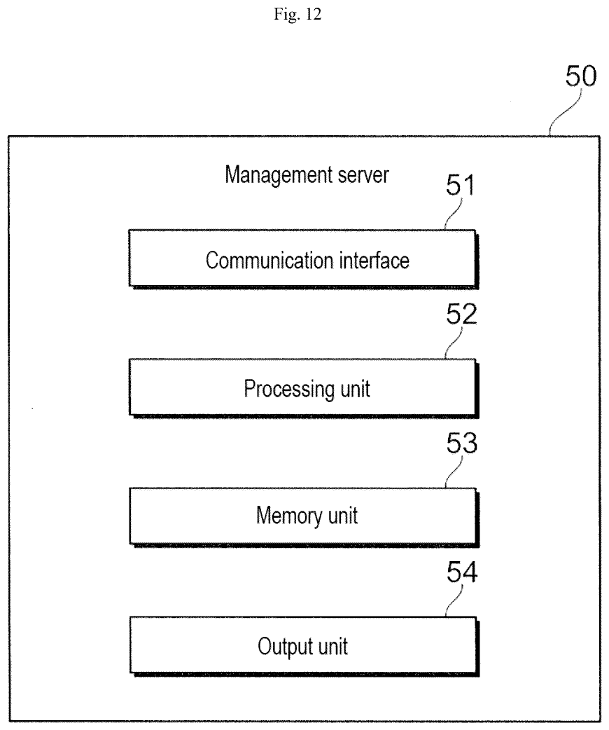

FIG. 12 shows the configuration of the management server 50. The management server 50 is a server for managing entry and exit of people to and from the smoking area 200, based on monitoring information afforded by the monitoring device 40. The management server 50 is a server which is connected to the network 60, and may be configured by a single server machine, or the functions of the management server 50 may be realized by multiple distributed server machines. Furthermore, the management server 50 may also be realized as a cloud server constructed using resources available in what is known as a cloud environment. The management server 50 comprises: a communication interface 51, a processing unit 52, a memory unit 53, and an output unit 54.

The communication interface 51 is an interface for connecting to the network 60. The management server 50 uses the communication interface 51 to acquire, from the monitoring device 40 via the network 60, information relating to the reception start date/time and reception end date/time for each transmitter 104 provided on a front panel 10 of an aerosol generating device 1. Furthermore, the management server 50 uses the communication interface 51 to connect to an Internet website or mail server via the network 60, in order to report the number of smokers in each smoking area 200, as calculated by means of the processing unit 52.

The processing unit 52 manages availability of the smoking area 200 in which the monitoring device 40 is installed. Specifically, the processing unit 52 calculates the number of smokers in the smoking area 200 on the basis of identification information of aerosol generating devices 1 acquired from the monitoring device 40, and information relating to the start of reception and end of reception for each aerosol generating device 1 identified by the identification information. As described above, when a user in possession of an aerosol generating device 1 enters the smoking area 200 and radio waves sent from the transmitter 104 are received by means of the monitoring device 40, a reception start date/time are specified for that aerosol generating device 1. Furthermore, when the user in possession of the aerosol generating device 1 moves away from the smoking area 200 so that the radio waves sent from the transmitter 104 are no longer received by the monitoring device 40, a reception end date/time are specified for that aerosol generating device 1. Accordingly, if a reception end date/time are not specified for the aerosol generating device 1 identified by the identification information after a reception start date/time has been specified, it will be understood that the user in possession of that aerosol generating device 1 is in the smoking area 200 where the monitoring device 40 which detected said aerosol generating device 1 is disposed. The processing unit 52 then calculates the current number of smokers in each smoking area 200 on the basis of the determination result. When a plurality of monitoring devices 40 are installed in a given smoking area 200, as described above, an aerosol generating device 1 detected by either or any of the monitoring devices 40 will be recognized as an aerosol generating device 1 which is present in that smoking area 200.

Furthermore, the processing unit 52 manages users of aerosol generating devices 1 in the smoking area 200. Specifically, the processing unit 52 measures the time for which each aerosol generating device 1 remains in a given smoking area 200, and saves the measured time. This enables promotions, etc. based on a history of users remaining in the smoking area 200 to be held. As an example of a possible promotion, the processing unit 52 specifies an aerosol generating device 1 which has been in the smoking area 200 for more than a predetermined threshold (e.g., 5 minutes), and then grants a reward to the user of the aerosol generating device 1 which was specified. The reward which is granted may be, for example, points or stamps, etc. which can be exchanged for goods such as smoking articles. In the case of points, these could be exchanged for goods according to the number of points accumulated, etc. In the case of stamps, different stamps could be awarded for each smoking area 200, and these could be exchanged for goods when a certain number of each type of stamp has been collected, etc.

The processing unit 52 is realized by one or more processors. A CPU, MPU, GPU, ASIC, FPGA, or DSP, etc. is used as the processor, for example. Furthermore, the processing unit 52 may also include a ROM for storing programs and computation parameters, etc., and a RAM for temporarily storing parameters, etc. which vary, as appropriate, according to the processing which is implemented.

The memory unit 53 stores the information acquired from the monitoring device 40 by means of the communication interface 51, namely the identification information of the transmitter 104 of the aerosol generating device 1, the reception start date/time, and the reception end date/time, this information being stored in association with the smoking area 200. The information relating to each aerosol generating device 1 will be referred to below as “device information”. Furthermore, the memory unit 53 stores information on the number of smokers, which was calculated by the processing unit 52, in association with the smoking area 200. Information relating to the availability of the smoking area 200 will be referred to below as “smoking area usage information”. The memory unit 53 is realized by a semiconductor memory such as a flash memory, or a magnetic disk, etc.

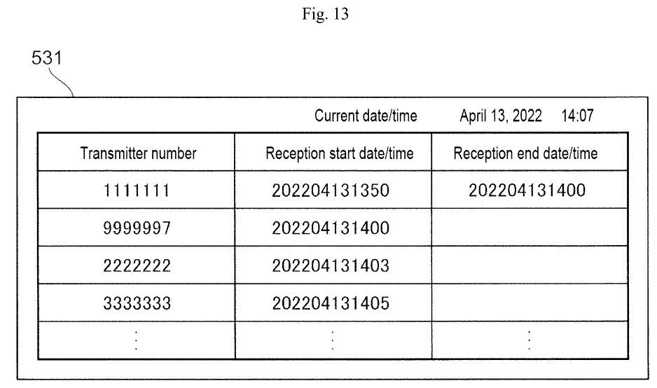

FIG. 13 shows an example of a management table for device information held in the memory unit 53. Identification information of transmitters 104 (denoted by “transmitter number” in the drawing) which was received by the monitoring unit 40, reception start date/time, and reception end date/time are recorded in the management table 531 shown in FIG. 13. The management table 531 in the drawing constitutes device information acquired from one monitoring device 40. It will be assumed that a management table 531 such as depicted is stored in the memory unit 53 for each monitoring device 40. It should be noted that the device information may be managed for each smoking area 200 where a monitoring device 40 is provided, rather than for each monitoring device 40. In this case, when a plurality of monitoring devices 40 are provided in one smoking area 200, device information acquired from the plurality of monitoring devices 40 provided in the same smoking area 200 may be collectively managed by means of a single management table 531. It should be noted that the example described here uses the transmitter number as the identification information of the transmitters 104, but the identification information is not limited to a number (digits) provided that the information enables a transmitter 104 to be identified.

In the example depicted, “202204131350” is recorded as the reception start date/time and “202204131400” is recorded as the reception end date/time for a transmitter 104 having the transmitter number “1111111”, for example. This reception start date/time is taken to indicate 13:50 on Apr. 13, 2022. This reception end date/time is similarly taken to indicate 14:00 on Apr. 13, 2022. It can be understood from this information that the user of the aerosol generating device 1 comprising the transmitter 104 having the transmitter number “1111111” stayed for 10 minutes, from 13:50 until 14:00 on Apr. 13, 2022, in the smoking area 200 where the monitoring device 40 corresponding to the management table 531 depicted is provided. Furthermore, “202204131400” is recorded as the reception start date/time for a transmitter 104 having the transmitter number “9999997”, but a reception end date/time is not recorded. It can be understood from this information that, at 14:00 on Apr. 13, 2022, the user of the aerosol generating device 1 comprising the transmitter 104 having the transmitter number “9999997” entered the smoking area 200 where the monitoring device 40 corresponding to the depicted management table 531 is provided, and has not since left the smoking area 200 (in other words, the user is still in this smoking area 200).

The history of users remaining in a smoking area 200 will be described. As indicated above, the processing unit 52 of the management server 50 acquires and manages a history of users of aerosol generating devices 1 remaining in a smoking area 200. The example above described a promotion where a reward is granted according to the time spent by a user of an aerosol generating device 1 in one smoking area 200, but it is additionally possible to collect history data, such as time spent, and frequency and tendency of visits by users of aerosol generating devices 1 to each specific smoking area 200 or smoking-related area where a monitoring device 40 is provided, such as a store or vending machine selling tobacco articles. This information may be used, for example, for users who frequently visit a specific smoking area 200 or other smoking-related area and for users who spend a long time in those areas, in order to provide services which improve convenience for the users according to their tendencies, and to hold promotions to grant rewards such as described above. In order to notify a user that a reward is being granted, the memory unit 53 stores identification information of an information terminal in the possession of the user, who is the recipient of the notification, in association with identification information of the transmitter 104 provided on the front panel 10 of the aerosol generating device 1 of that user. The information terminal in the possession of the user is an example of an external device. For the identification information of the information terminal, a telephone number or email address, etc. may be used as information which can be used in order to specify and notify the information terminal.

The output unit 54 reports the information obtained by processing performed by the processing unit 52, and provides a notification to the user of a specific aerosol generating device. As a specific example, information on the number of users of aerosol generating devices 1 in a smoking area 200, or other information, is displayed on a website. Furthermore, for example, email or notification application software is used to notify an aerosol generating device 1 user of information such as the user's behavior history and history of remaining in a smoking-related area, which are managed for each transmitter 104. When the information is displayed on a website, the output unit 54 creates a web page including the information to be displayed, and uploads this web page to a web server which is not depicted, for example. Furthermore, when a specific user is notified of information by using email, for example, the output unit 54 receives an email enquiry from the user, and a notification is made by an email response to the user who made the enquiry. When a specific user is notified of information by using notification application software, the output unit 54 provides a message notification by means of the application software if a notification condition set by this software has been fulfilled, for example. Examples of notification conditions that may be cited include receipt of an enquiry from the user by means of the software, and acquisition of a reward based on the history of the user remaining in a smoking area 200. Acquisition of a reward based on the history of the user remaining in a smoking area 200 is notified by reading, from the memory unit 53, the identification information of the information terminal associated with the identification information of the transmitter 104 provided on the front panel 10 of the aerosol generating device 1 of the user who has acquired the reward.

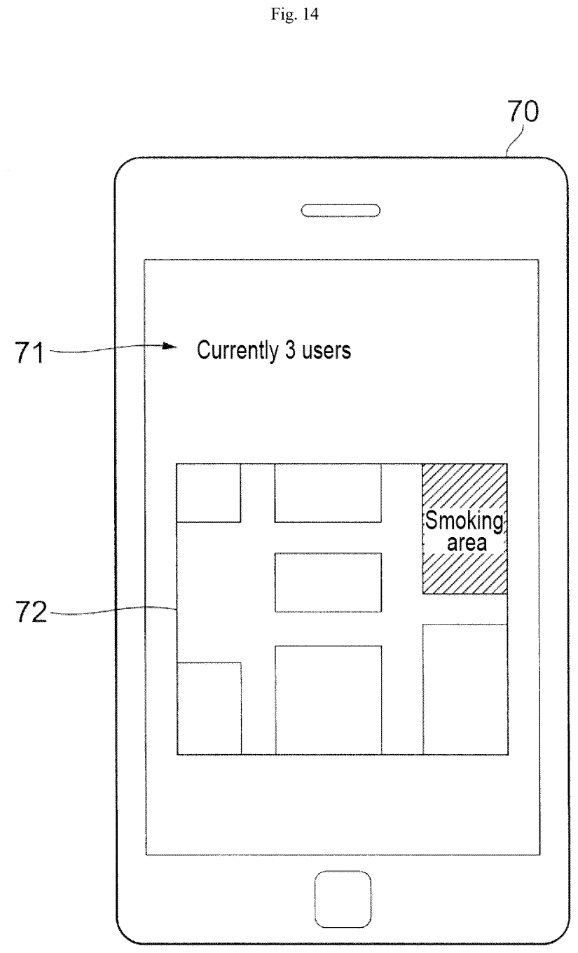

FIG. 14 shows an example of a web page reporting information of a smoking area 200. The diagram shown in FIG. 14 is an example of a web page reporting the number of users of aerosol generating devices 1 in a smoking area 200. In the example depicted, the web page is displayed on a portable terminal 70 such as a smartphone. A text message 71 giving information on the number of users, and a map 72 showing the location of the smoking area 200 are displayed on the web page depicted. In the example depicted, the text “Currently 3 users” is displayed as the text message 71. The information given in the text message 71 is a message relating to the smoking area 200 shown on the map 72. It should be noted that the location of one smoking area 200 is displayed on the map 72 in the example depicted, but if there are a number of smoking areas 200 nearby, it is equally possible to adopt a configuration in which information on the number of users in each smoking area 200 is displayed side-by-side or displayed by switching. It should be noted that the location of the smoking area 200 and the information on the number of users are reported by means of a web page in FIG. 14, but it is also possible for other smoking-related areas (stores and vending machines) where a monitoring device 40 is installed to be further displayed on the map, and for a text message indicating the number of users of aerosol generating devices 1 in each place to be displayed.

Embodiments of the present invention were described above, but the technical scope of the present invention is not limited to the embodiments above. For example, the embodiments above described a configuration in which availability of a smoking area 200 and user history information were reported on a website or reported using email. This assumes that the user of an aerosol generating device 1 accesses the information using a portable terminal 70 such as a smartphone, as described with reference to FIG. 14. At the same time, a display means employing a liquid crystal display or the like may be provided on the aerosol generating device 1 or the front panel 10 thereof, the management server 50 may send reporting information to the communication unit 105 on the front panel 10 or the communication unit 205 in the main body device 20, and this information may be reported by display on the display means. The present invention additionally includes various modifications and component substitutions that do not depart from the scope of the technical concept of the present invention.

### Summary

It should be noted that the present disclosure includes the following features.

(1)

A smoking-related information management system comprising: a cover which is attached to a main body having a heating unit for heating a substrate that contains an aerosol source and thereby permits heating of the heating unit by means of the main body, the cover having a transmitter for sending electromagnetic waves; a receiver which is provided in a smoking-related area and receives the electromagnetic waves emitted from the transmitter; and a management server connected to the receiver, wherein the receiver sends, to the management server, identification information of the transmitter on the cover, a date and time of the start of reception of the electromagnetic waves emitted from the transmitter, and a date and time of the end of reception of said electromagnetic waves, and the management server has a memory unit for associating and storing the identification information of the transmitter, and the date and time of the start of reception of the electromagnetic waves and the date and time of the end of reception of said electromagnetic waves.

(2)

The cover as disclosed in (1), wherein the management server has a calculation unit for calculating the number of transmitters for which reception of the electromagnetic waves has not ended after the start of reception thereof.

(3)

The cover as disclosed in (2), wherein the management server has a reporting unit for reporting the number calculated by the calculation unit.

(4)

The cover as disclosed in (1), wherein the memory unit of the management server stores identification information of an external device other than the cover in association with the identification information of the transmitter, and the management server has a transmission unit which, when a time from the start of reception of the electromagnetic waves until the end of reception thereof has exceeded a predetermined time, sends information granting a reward to the external device stored in association with the identification information of the transmitter sending the electromagnetic waves.

### REFERENCE SIGNS LIST

1 . . . Aerosol generating device; 10 . . . Front panel; 10C, 20C . . . Magnet; 20 . . . Main body device; 101A, 201A . . . Secondary battery; 20B . . . Button; 21 . . . Connector; 22 . . . Hole; 30 . . . Shutter; 40 . . . Monitoring device; 41 . . . Receiver, 42 . . . Communication control unit; 43 . . . Communication interface; 50 . . . Management server; 51 . . . Communication interface; 52 . . . Processing unit; 53 . . . Memory unit; 54 . . . Output unit; 101, 201 . . . Power source unit; 101B . . . Step-up/step-down DC/DC circuit; 102 . . . Charging circuit; 103 . . . Electrical supply circuit; 104 . . . Transmitter; 105 . . . Communication unit; 106 . . . Control unit; 201B . . . Power supply unit; 202 . . . Sensor unit; 203 . . . Notification unit; 204 . . . Memory unit; 205 . . . Communication unit; 206 . . . Control unit; 207 . . . Heating unit; 208 . . . Heat insulating portion; 209 . . . Holding portion; 210 . . . Stick-type substrate

1. A smoking-related information management system comprising: a cover which is attached to a main body having a heating unit for heating a substrate that contains an aerosol source and thereby permits heating of the heating unit by means of the main body, the cover having a transmitter for sending electromagnetic waves;
a receiver which is provided in a smoking-related area and receives the electromagnetic waves emitted from the transmitter; and
a management server connected to the receiver, wherein
the receiver sends, to the management server, identification information of the transmitter on the cover, a date and time of the start of reception of the electromagnetic waves emitted from the transmitter, and a date and time of the end of reception of said electromagnetic waves, and
the management server has a memory unit for associating and storing the identification information of the transmitter, and the date and time of the start of reception of the electromagnetic waves and the date and time of the end of reception of said electromagnetic waves.

2. The smoking-related information management system as claimed in claim 1, wherein the management server has a calculation unit for calculating the number of transmitters for which reception of the electromagnetic waves has not ended after the start of reception thereof.

3. The smoking-related information management system as claimed in claim 2, wherein the management server has a reporting unit for reporting the number calculated by the calculation unit.

4. The smoking-related information management system as claimed in claim 1, wherein the memory unit of the management server stores identification information of an external device other than the cover in association with the identification information of the transmitter, and
the management server has a transmission unit which, when a time from the start of reception of the electromagnetic waves until the end of reception thereof has exceeded a predetermined time, sends information granting a reward to the external device stored in association with the identification information of the transmitter sending the electromagnetic waves.
